(19) United States
(12) Patent Application Publication
(10) Pub. No.: US 2008/0152860 A1
(43) Pub. Date: Jun. 26, 2008

(54) Conjoined absorbent exercise mat

(76) Inventor: Jacqueline Laverne Meyer, Athens, GA (US)

Correspondence Address: Hill, Kertscher & Wharton, LLP, Suite 800, 3350 Riverwood Parkway, Atlanta, GA, 30339, US

(21) Appl. No.: 11/644,685

(22) Filed: Dec. 22, 2006

(51) Int. Cl. B32B 3/06; B32B 7/12; B32B 37/00

(52) U.S. Cl. 428/100; 428/221; 428/99; 428/354; 156/60

(57) ABSTRACT

A washable absorbent fabric that adheres to a portion of an exercise mat is disclosed herein for use during exercising. The absorbent fabric is made of a washable material. The absorbent fabric covers virtually the entire surface of one side of the exercise mat while leaving the opposite side of the mat exposed so that the mat can have direct contact with the ground. The absorbent fabric adheres to the mat to prevent slippage during exercising.

### CROSS REFERENCE TO RELATED APPLICATIONS

Not Applicable

### STATEMENT REGARDING FEDERALLY SPONSORED RESEARCH OR DEVELOPMENT

Not Applicable

### FIELD OF INVENTION

The present invention relates to the field of exercise accessories and, in particular, to mechanisms for the prevention of fabric from slipping off universal exercising mats. Specifically, the present invention relates to an absorbent fabric that adheres to an exercise mat that inhibits the slippage of the fabric from the mat during its use.

### BACKGROUND OF THE INVENTION

Exercise mats are used by individuals for support, comfort, and traction. Absorbent material is also used by individuals during exercising to absorb perspiration.

These universal exercise mats are typically rectangular in shape, are designed to lay flat on the ground and are used in exercise programs such as yoga. These mats are tacky in nature so that the mat does not move once placed on the ground. The exercise mat is to provide support and traction while the individual is exercising.

Most individuals perspire while exercising. Absorbent materials are commonly used while exercising to absorb perspiration. The mat may become slippery during usage due to perspiration by the user, making exercise poses more difficult to maintain. Absorbent materials can be used to wipe down the exercise mat to eliminate or reduce the quantum of perspiration that has collected on the mat. However, when the individual begins the next exercise, the mat may again become slippery from new perspiration. The individual then has to stop the exercise to wipe the mat off (again and again), until the exercising is complete. The need arises that the absorbent material be washable.

Various attempts to solve the need for a removable, absorbent and washable mat cover and absorbent materials used during exercising are disclosed in U.S. Pat. No. 4,885,196 for “Exercise Towel with Magnetic Anchoring Means,” U.S Pat. No. 5,060,943 for “Gripping aid,” U.S. Pat. No. 5,099,530 for “Cover for Exercise Pad,” and U.S. Pat. No. 6,751,816 for “Exercise Mat Ensemble and Method of Use.”

In the prior inventions, removable covers for exercise mats have been created that completely encompass the mat. Once a cover encompasses the entire mat, the mat loses its traction with the ground. A sheet that lies over the mat has been designed but said invention does not provide a way to secure the sheet to the exercise mat.

The present invention is distinguished over the prior art in general and these patents in particular by an absorbent fabric that can be conjoined to the mat but which does not completely encompass the mat. The absorbent fabric is only placed on one side of the mat so that the tacky side of the mat can make contact directly with the ground or surface below it. The absorbent fabric has at least one securing method on it so the fabric can be affixed to the mat to ensure the fabric will not slip while an individual is using the mat. The securing method is not permanent in nature so the washable fabric can be removed, for purposes such as washing or storing.

### SUMMARY OF THE INVENTION

It is therefore an object of this invention to provide an absorbent fabric conjoined to an exercise mat.

It is another object of this invention to provide an absorbent fabric which can be affixed to an exercise mat, but without encompassing the mat in its entirety.

Still another object of the invention is to provide an absorbent fabric that is washable.

### BRIEF DESCRIPTION OF THE DRAWINGS

Further objects of this invention, together with additional features contributing thereto, and advantages accruing there from, will be apparent from the following description of the preferred embodiment of the invention when read in conjunction with the accompanying drawings wherein:

FIG. 1 is a top view of the preferred embodiment.

FIG. 2 is a bottom view of the preferred embodiment.

FIG. 3 is a bottom view of a section of the preferred embodiment.

FIG. 4 is a perspective view of the absorbent fabric to the exercise mat of the preferred embodiment.

FIG. 5 is a cross-sectional view of the preferred embodiment attached to the exercise mat.

### DETAILED DESCRIPTION OF THE DRAWINGS

There is shown in FIG. 1, the top view of an absorbent fabric 20 with dimensions of 5 foot 8 inches by 2 feet. The absorbent fabric 20 is rectangular in nature. The absorbent fabric 20 suitable for use in the preferred embodiment is any of a variety of commercially available water absorptive materials and liners, such as MicroTex Professional Detailing cloths available at the Dollar General Store and Unger Smart Color Microwipe™ 4000 available at janitor supply stores.

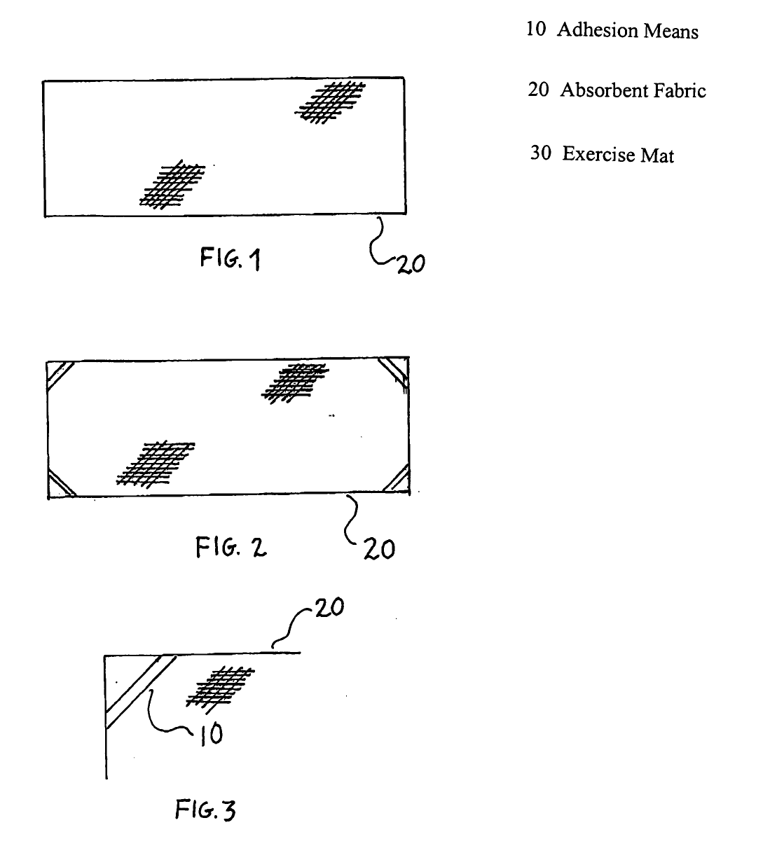

As depicted in FIG. 2, the underside of the absorbent fabric is shown with the same rectangular dimensions as in FIG. 1. FIG. 2 displays the adhesion means 10 in the four corners of the absorbent fabric 20. The length from each end of the fabric 20 to where each adhesion mechanism is secured to the fabric 20 is approximately 4 inches long in the preferred embodiment. However, it will be obvious to anyone of ordinary skill in the art that there are a variety of dimensions that can be used for the length of the adhesion means 10. Each of the four adhesion means 10 shown in FIG. 2, to allow the fabric 20 to be conjoined to the mat, has a hypotenuse of approximately 5.6 inches in the preferred embodiment, but there are a variety of potentially acceptable dimensions, as will be evident to one of ordinary skill in the art.

FIG. 3 depicts one adhesion means 10 as used in tandem with the absorbent fabric 20 in a larger view. The adhesion means 10 of the preferred embodiment may be made from any material that is suitable for elastic manipulation, including any of a variety of commercially available rubber and plastic materials that are elastomeric and that will stretch into place when pulled. The hypotenuse of the adhesion material is approximately 5.6 inches long with a 1 inch thickness in the preferred embodiment, but there are a variety of potentially acceptable dimensions, as will be evident to one of ordinary skill in the art. Although the adhesion means 10 is described in terms of a particular embodiment known to the inventor, one of ordinary skill in the art will recognize that other adhesion means 10 exist in the art, including the use,of Velcro strips to secure the mat to the absorbent materials, or the use of thin, lightly adhesive strips that are capable of separating and re-attaching.

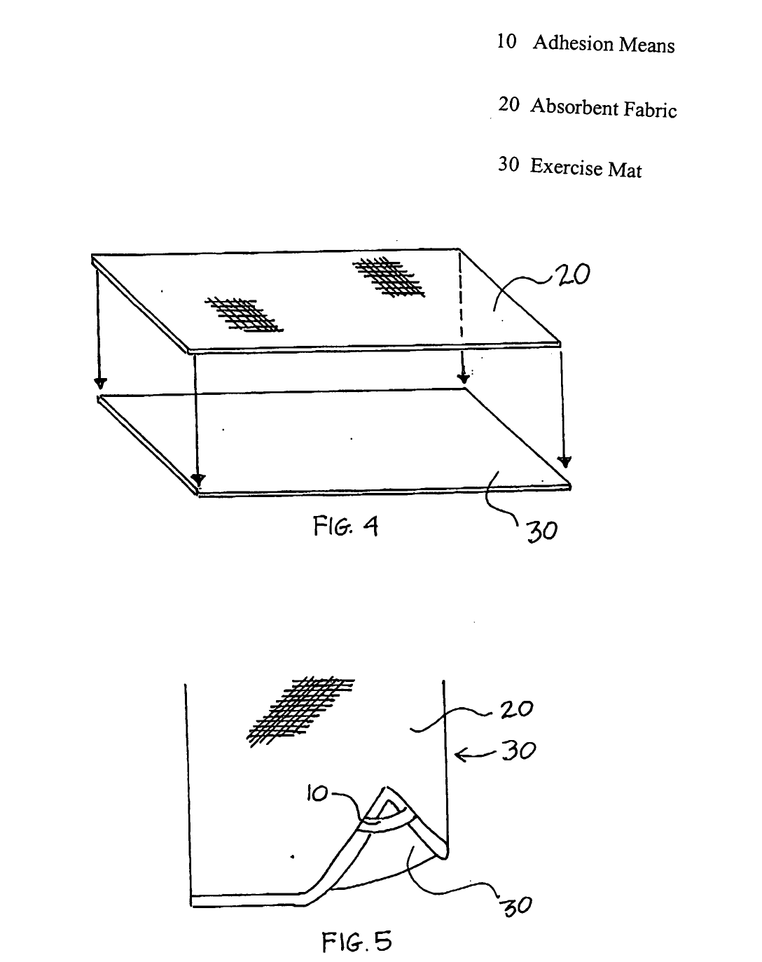

As suggested by FIG. 4, the absorbent fabric 20 in the preferred embodiment preferably extends down over the exercise mat 30 so as to cover the top side of the mat substantially or in its entirety. The bottom side of the mat is left exposed so that it can directly contact the substrate, with the exception of contact between the absorbent fabric 20 and the mat 30 via the adhesion means 10.

FIG. 5 logically depicts the absorbent fabric 20 being secured to the exercise mat 30 of the preferred embodiment via the use of the adhesion means 10 on each of the corners of the mat 30. A person of ordinary skill in the art will recognize that, depending upon the particular adhesion means 10 used to fasten the absorbent fabric 20 to the mat 30, the number of adhesion means 10 as fasteners used and the placement of said fasteners may vary.

While the invention has been shown, described and illustrated in detail with reference to the preferred embodiment, and possible modifications thereof, it will be understood by those skilled in the art that equivalent changes in form and detail may be made therein without departing from the true spirit and scope of the invention as claimed.

I claim:

1. An absorbent exercise mat unit comprising;
An exercise mat;
An absorbent fabric configured to cover substantially the length and width of only one side of said mat;
Said mat and said absorbent fabric each placed in contact with at least one adhesion means; and
Said adhesion means being removable from the exercise mat.

2. The unit according to claim 1 wherein
said absorbent fabric comprises a washable fabric material.

3. The unit according to claim 1 wherein said adhesion means includes a plurality of elastic bands.

4. The unit according to claim 1 wherein said adhesion means includes a plurality of Velcro strips.

5. The unit according to claim 1 wherein said adhesion means includes a plurality of adhesive strips.

6. An absorbent exercise mat unit comprising;
An exercise mat;
An absorbent fabric configured to cover substantially the length and width of only one side of said mat;
Said mat and said absorbent fabric each placed in contact with at least one fastening device; and
Said fastening device being removable from the exercise mat.

7. The unit according to claim 6 wherein said absorbent fabric comprises a washable fabric material.

8. The unit according to claim 6 wherein said fastening device includes an elastic band.

9. The unit according to claim 6 wherein, said fastening device includes a Velcro strip.

10. The unit according to claim 6 wherein said fastening device includes an adhesive strip.

11. A method comprising the steps of:
a. Placing an absorbent fabric configured atop an exercise mat so as to cover substantially the length and width of only one side of said mat;
b. Using a fastener or adhesive to conjoin said fabric to the top face of said mat, the fabric being removable for subsequent removal from contact with said mat; and
c. Exercising on top of said mat.

12. The method of claim 11, wherein said fastener or adhesive is one or more of a sticky material, an elastic band, and/or a Velcro strip.
